(19) United States
(12) Patent Application Publication
(10) Pub. No.: US 2002/0020576 A1
(43) Pub. Date: Feb. 21, 2002

(54) Wheel Thruster

(76) Inventor: Ernest E. Anderson, Evansville, IN (US)

Correspondence Address: GARY K. PRICE, 111 S.E. THIRD STREET, SUITE 201, EVANSVILLE, IN, 47708-1431, US

(21) Appl. No.: 09/911,684

(22) Filed: Jul. 24, 2001

Related U.S. Application Data
(60) Provisional application No. 60/225,653, filed on Aug. 16, 2000.

(51) Int. Cl. B60K 3/00

(52) U.S. Cl. 180/302; 180/54.1

(57) ABSTRACT

A wheel thruster for converting rotary motion to a unidirectional thrust resulting from an unbalance of centrifugal force produced by air or steam pressure and rotation of weights about an axis, comprising a housing, a rotatable wheel within the housing, the rotatable wheel mounted on a shaft for rotation about a common axis, a plurality of weights connected to the wheel; a plurality of bearings located between the shaft and the wheel; the shaft being powered by a motor; and, a means for supply air or steam pressure, which pressure is distributed within the housing producing ambient pressure to the rotating wheel.

### CROSS REFERENCES TO RELATED APPLICATIONS

U.S. Provisional Application for Pat. 60/225,653, filed Aug. 16, 2000, with title, “Wheel Thruster” which is hereby incorporated by reference. Applicant claims priority pursuant to 35 U.S.C. Par. 119(e)(i).

### BACKGROUND OF THE INVENTION

1. Field of the Invention

This invention relates to a wheel thruster apparatus, and more particularly to an apparatus for converting rotary motion to a unidirectional thrust resulting from an unbalance of centrifugal force caused by air or steam pressure and a rotation of weights about an axis.

2. Brief Description of Prior Art

Systems for converting rotary motion into unidirectional motion by rotating weights about an axis are known in the art. However, previous embodiments generally rely on mechanical means to cause a displacement of rotary masses, thereby causing the unbalance centrifugal force. The prior art devices rely upon the displacement of rotating masses in which the masses are oscillated toward and away from the axis of rotation. Consequently, unbalanced centrifugal force is generated in a preselected direction, and the direction of the unbalanced centrifugal force is selective. These devices are overly complex to manufacture, require complex systems and critically interrelated rotating components, and the like. Therefore, a need exists for a less complicated wheel thruster system that converts rotary motion to unidirectional motion by rotating weights about an axis.

### SUMMARY OF THE INVENTION

The present invention produces thrust from an unbalance centrifugal force that is consistently located at a single location on a rotatable wheel by converting rotary motion to unidirectional motion, including a motor, a rotatable wheel carried by a housing, an adjustable vent assembly, said rotatable wheel mounted on a shaft for rotation around a common axis, a plurality of mass blocks situated within a plurality of milled pockets evenly spaced circumferentially around the wheel, an air or steam pressure means connected to the vent assembly that provides said air or steam pressure to the wheel, and a flow divider that properly distributes said air pressure around the circumference of the wheel to create said unbalance centrifugal force that produces said thrust.

In the present invention, rotary motion of the wheel is converted to unidirectional motion due to a resultant unbalanced force produced by rotating the wheel, and the introduction of air or steam pressure. The unidirectional characters of the unbalanced centrifugal force is responsible for thrust movement. The unbalanced centrifugal force is, in effect, a thrust force capable of moving a movable frame or vehicle, without any requirement of traction between the frame or vehicle and supporting surface or medium.

In a further embodiment, the mass blocks are contained about the perimeter of the wheel design by a band thereby eliminating the need for said plurality of milled pockets.

The present apparatus in its various embodiments, as discussed herein, can be utilized to propel virtually any form of movable frame, as well as vehicles of all types. Thus, the apparatus can be used to propel aircraft, space vehicles and the like.

### BRIEF DESCRIPTION OF THE DRAWINGS

FIG. 1 is a perspective view of the present invention, namely a wheel thruster assembly.

FIG. 2 is a perspective view of the housing and rotatable wheel of the assembly of FIG. 1.

FIG. 3 is an exploded perspective view of the components of the assembly of FIG. 1.

FIG. 4 is a top view of the assembly of FIG. 2.

FIG. 5 is an exploded sectional view of the rotatable wheel.

FIG. 6 illustrates an exploded perspective view of a second embodiment of the present invention.

### DESCRIPTION OF THE PREFERRED EMBODIMENTS

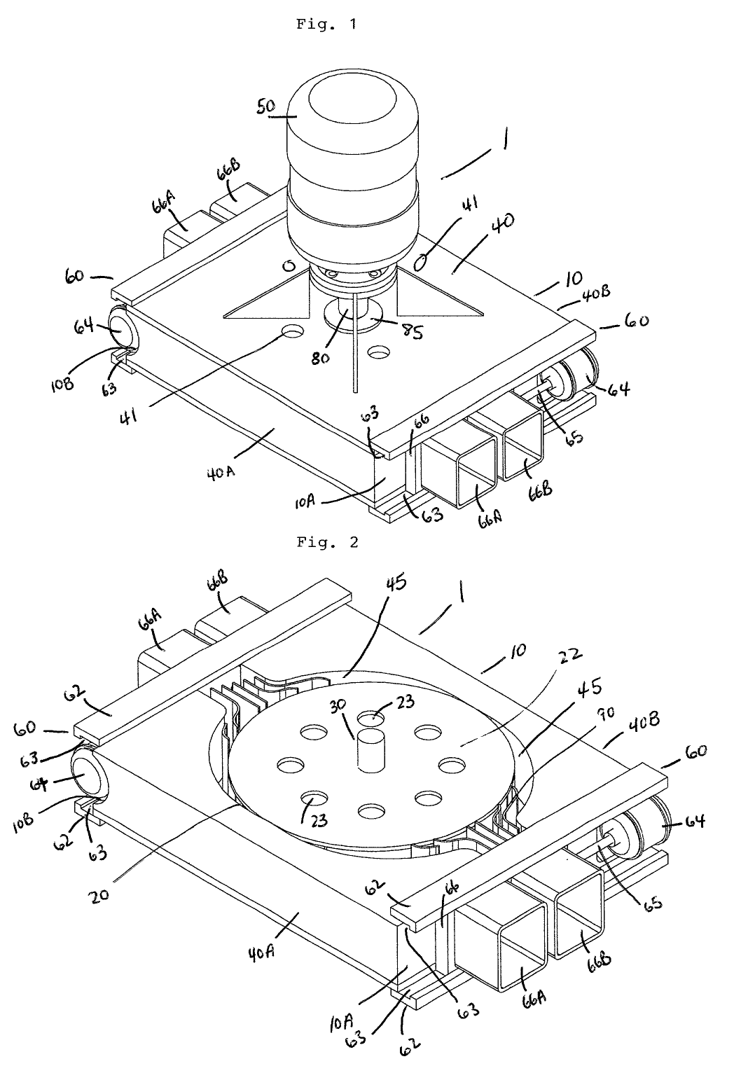

FIG. 1 illustrates the preferred embodiment of the present invention, an apparatus which is a wheel thruster 1 that produces thrust from an unbalance centrifugal force that is consistently located at a single location on a cylindrical rotatable wheel 20 by converting rotary motion to unidirectional motion, including a housing 10, a shaft 30, a motor 50, an adjustable vent assembly 60, and a means for supplying air or steam pressure (not shown). The motor 50, as will be seen, is operative to effect rotation of the wheel 20 of the apparatus 1. Further, said motor 50 to effectuate rotation of the wheel 20 may be varied to suit the particular requirements of each application, and the present invention is not limited to, for example, internal combustion engines, electric motors, or the like.

Referring to FIGS. 2, 3 and 4, the rotatable wheel 20 includes a top plate 22 having a plurality of relief vents 23, a plurality of mass blocks 25, a wheel center 27 having a plurality of vents 28, and in the preferred embodiment, a plurality of milled pockets 35 which are open at its outer periphery and are evenly spaced circumferentially around the wheel 20, the number of pockets 35 corresponding to the number of mass blocks 25. Each milled pocket 35 having a first edge 35A and a second edge 35B, which edges 35A, 35B slidably accept the mass blocks 25. Consequently, the pockets 35 and blocks 25 constitute a rotating “floating” mass within the apparatus 1. The rotatable wheel 20 further includes a bottom plate 39.

The housing 10 includes a first end 10A and a second end 10B, a top 40 having a top mount 43 and a plurality of vent clearances 41, sides 40A and 40B, and a bottom 42, defining a chamber 45 contained therein. The top plate 22, the wheel center 27, the bottom plate 39, the top 40 and the bottom 42 of the housing 10 include central openings through which the shaft 30 is disposed. With this arrangement, any rotation of the shaft 30 is accompanied by corresponding rotation of the wheel 20 and the plurality of mass blocks 25.

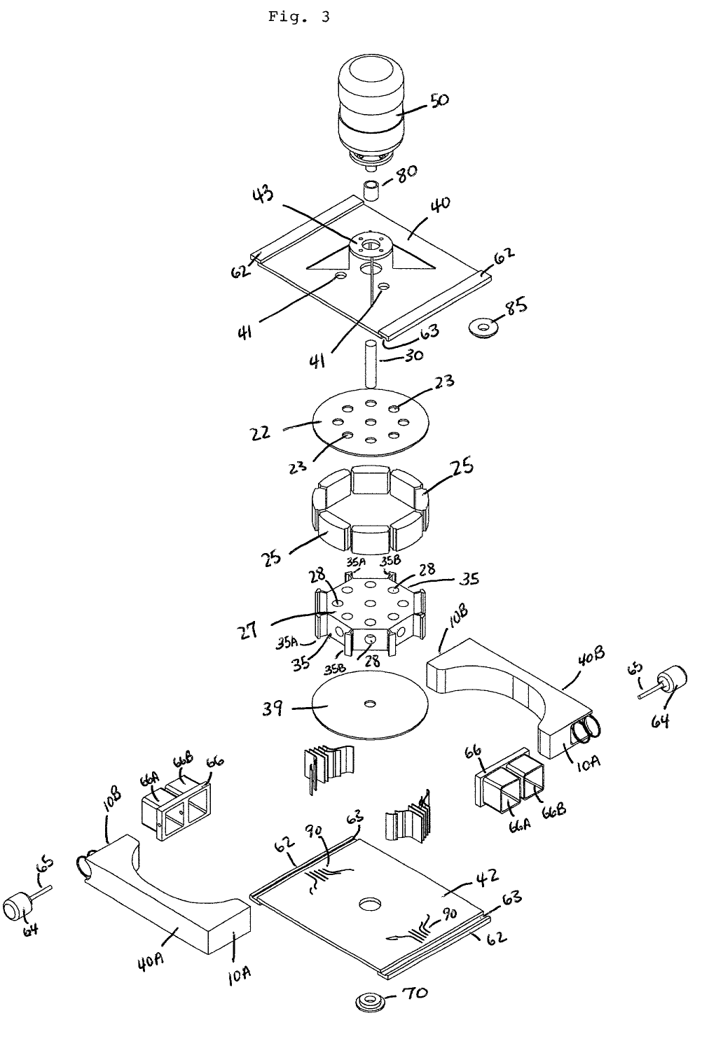

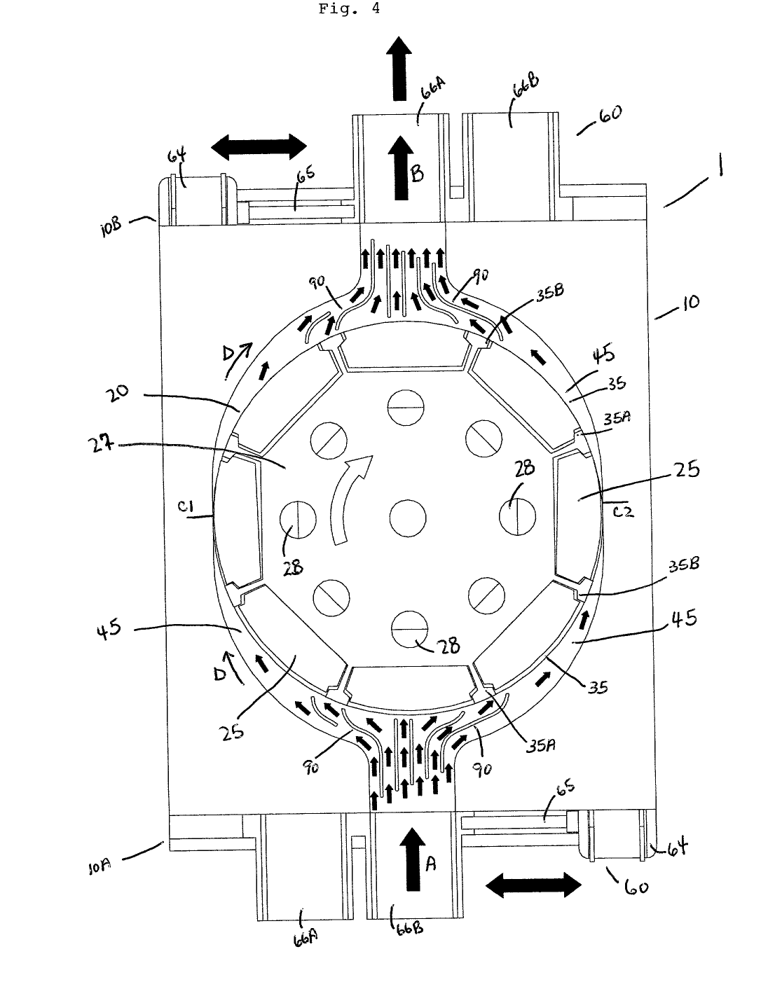

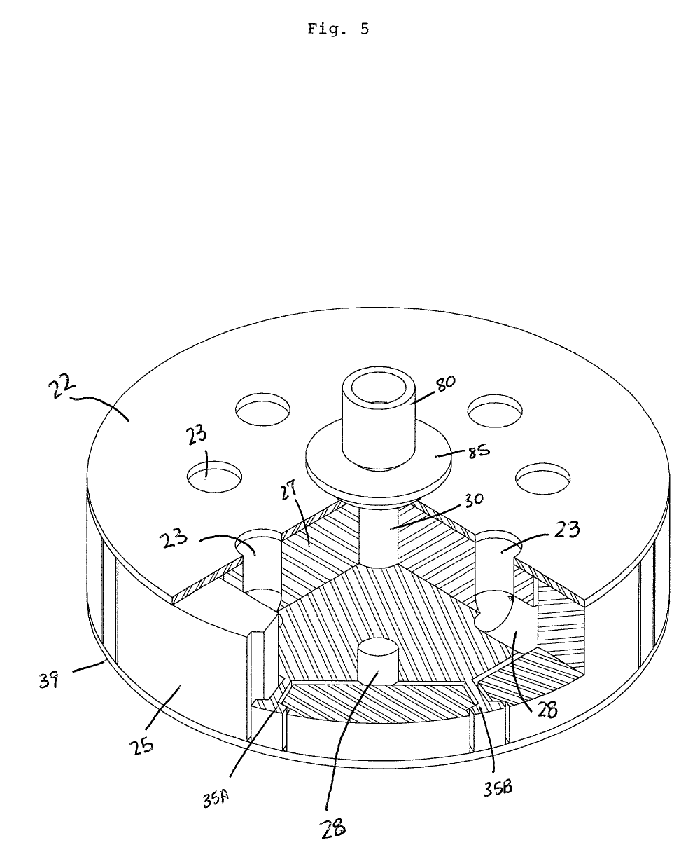

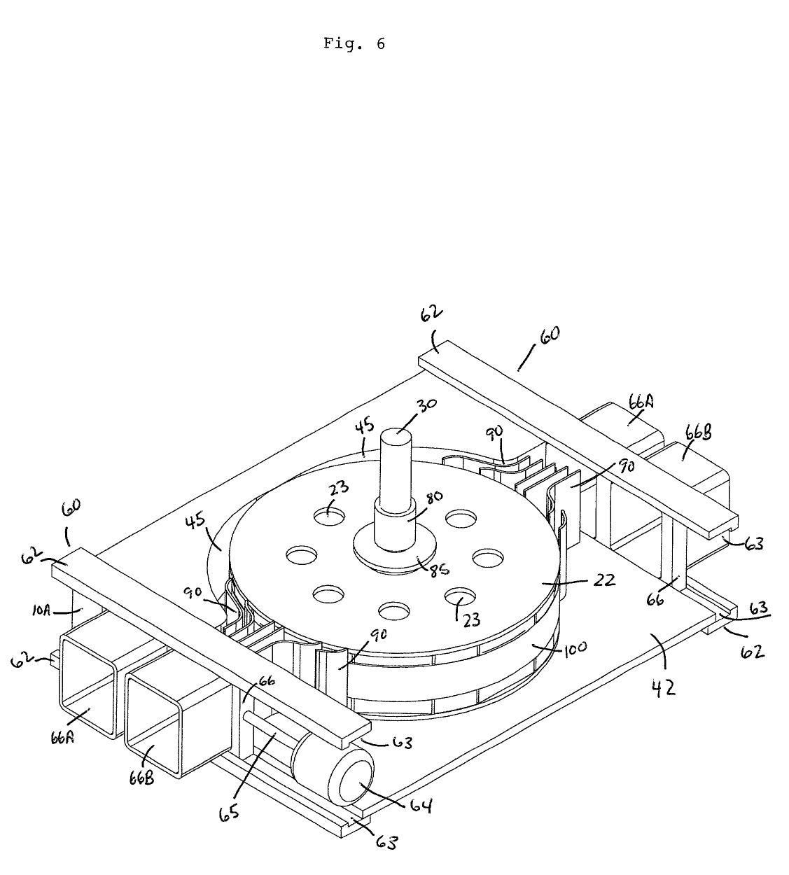

Referring to FIG. 3, the adjustable vent assembly 60 includes a frame 62 defining grooves 63 therein, a valve motor 64 having a screw 65, and a vent support 66 having vents 66A and 66B, said vent support 66 is slidably received within the grooves 63 of the frame 62 (shown in FIGS. 1 and 2). Further, said screw 65 is threadably attached to the side of the vent support 66.

The motor 50, top 40, and rotatable wheel 20 are mounted to the bottom 42 of the housing 10 using a bushing 70 attached to the shaft 30 as shown in FIG. 3. Further, as shown in FIG. 3, the motor 50 is connected to the shaft 30 and top mount 43 of the top 40 with a coupler 80 and a washer 85.

The assembly 1 further includes a flow divider 90 in the housing 10 that, as will be described, properly distributes incoming air pressure within the chamber 45 around the circumference of the rotatable wheel 20.

The air or steam pressure means is connected to either the vent 66A or 66B of the vent assembly 60 as will be discussed, and distributes air or steam pressure through the flow divider 90 and to the wheel 20 contained within the housing 10. The particular means for providing such air or steam pressure can be varied to suit the particular requirements of each application.

As an example, and shown in FIG. 4, air or steam pressure is distributed into vent 66B in the direction of arrow A. Such air or steam passes through the flow divider 90 and into the chamber 45, and distributed around the circumference of the rotatable wheel 20. Such air is expelled through vent 66A on the opposite side of the apparatus 1 in the direction of arrow B. The incoming pressure shown as arrow A applies an inward force to the wheel 20. An ambient pressure is created as a result of the incoming pressure and rotation of the wheel 20. The ambient pressure is partially released from the housing 10 through the vent 66A shown as arrow B.

In operation, the unbalanced centrifugal force is a result of varying the center of gravity of the mass blocks 25 from the wheel center 27. This is accomplished according to the present invention, by a transfer of the mass blocks 25 inwardly and outwardly in a weightless state, the combination of these mass changes causing the desired unbalanced centrifugal force.

The rotation of the shaft 30 is effected by starting the motor 50, and results in the rotation of the rotatable wheel 20 and the plurality of mass blocks 25. When the inclusion of the incoming air pressure is applied through the vent 66B (arrow A in FIG. 4), the mass blocks 25 are urged inward towards the wheel center 27 and as the wheel 20 rotates in the direction of Arrow D (shown in FIG. 4), away from the high pressure side of the apparatus 1, the mass blocks 25 are generally forced outwardly away from the center 27. When the mass blocks 25 pass the center line which is marked C1 in FIG. 4, the mass blocks 25 will be at an external diameter position that causes the wheel 20 to be unbalanced. The collective effect of such an unbalance of the wheel 20 causes an unbalanced centrifugal force to develop, which results in the frame or vehicle to which the apparatus 1 is attached move in the direction it is most off balanced thereby creating a thrust action. The speed of movement in the direction of the off balance can be controlled by varying the rate of rotation of the shaft 30, or by controlling the degree of air pressure thereby varying the angular position the mass blocks 25 move inward and outwardly.

With the inclusion of the incoming air under pressure, and the rotation of the wheel 20, this results in a variation of the centrifugal force produced on the wheel 20 by the plurality of mass blocks 25. As the speed in which the wheel 20 rotates increases, the speed will eventually cause the mass blocks 25 to be weightless. Once the mass blocks 25 are in a weightless state, the force from the ambient pressure will cause the mass blocks 25 as they pass the center line C1 in FIG. 4, to extend outwardly from the wheel center 27. As the mass blocks 25 pass the said center line they continue to rotate toward the outlet vent 66A (arrow B). The result is an unbalanced wheel 20 that causes the unbalanced wheel 20 to move away from the center of rotation. The resulting unbalance of centrifugal force produces a unidirectional thrust in the direction of, in this example, the said outlet vent 66A.

As shown in FIGS. 1-4, the adjustable vent assembly 60 is situated on both ends of the apparatus 1. In the previous example, incoming air pressure was applied through the vent 66B of the vent assembly 60 situated on the first end 10A of the housing 10. To change direction of the thrust, involves applying incoming pressure to the opposite side vent assembly 60 situated on the second end 10B of the housing 10. In the previous example, incoming pressure was received by vent 66B on the first end 10A of the apparatus 1 (referenced as arrow A) and expelled through vent 66A on the second end 10B of the apparatus 1 (arrow B). To change the direction of thrust, incoming air pressure would be received by vent 66B on the second end 10B of the housing 10, and expelled through the vent 66A on the first end 10A of the housing 10. When one of the vents 66A or 66B on the end of the apparatus 1 is being used to receive or expel air as described above, the remaining vent on that end of the apparatus 1 is slidably blocked, as will be discussed, by either the end 10A or 10B. As best shown in FIGS. 1 and 2, selection of the vent 66A or 66B is to receive or expel air and the vent 66A or 66B to be blocked, is adjusted by slidably moving vent support 66 using valve motor 64 turning screw 65. The screw 65 is threadably attached to the side of the vent assembly 66, so that the motor 64, when activated, slidably pulls or pushes the vent support 66 within the grooves 63 of the frame 62 of the vent assembly 60 such that the selected vent 66A or 66B is blocked by ends 10A or 10B.

Said vents 23, 28 and 41 cooperatively allow pressure to be released within the chamber 45 caused by the inclusion of the incoming pressure and the rotation of the wheel 20; otherwise, too much internal pressure within the chamber 45 would prevent or restrict rotational movement of the mass blocks 25. When the mass blocks 25 pass the center line C1 of the rotation, shown in FIG. 4, the vents 28 serve as an intake allowing to draw air behind the mass blocks 25; when the mass blocks 25 pass the opposite center line C2 on the apparatus 1, the vents 28 become an exhaust allowing it to expel air so the mass block 25 can shift. Having a plurality of said vents 28, including vents 28 in the milled pockets 35 behind the mass blocks 25, allows release of such pressure regardless of the direction of the wheel 20 rotation.

Referring now to FIG. 6, there is illustrated a second embodiment of the present invention. Where the components of the apparatus 1 are identical, except, as shown in FIG. 6, a band 100 is wrapped around the mass blocks 25. Such band 100 replaces the milled pockets 35 described in the first embodiment. In this embodiment, as shown in FIG. 6, the mass blocks 25 are held in place by the band 100, the top plate 22 and the bottom plate 39 of the rotatable wheel 20. The operation of the apparatus 1 would be as described in the first embodiment.

Although the description above contains many specificities, these should not be construed as limiting the scope of the invention but as merely providing illustrations of some of the presently preferred embodiments of this invention. Thus, the scope of the invention should be determined by the appended claims in the formal application and their legal equivalents, rather than by the examples given.

I claim:

1. A wheel thruster apparatus that converts rotary motion into a unidirectional thrust capable of moving a movable frame or vehicle resulting from an unbalance of centrifugal force caused by air or steam pressure and a rotation of mass blocks around an axis, comprising:
a cylindrical rotatable wheel including a wheel center, a plurality of milled pockets which are opened at its outer periphery and evenly spaced circumferentially around the rotatable wheel, and a plurality of mass blocks slidably received by said milled pockets;
a housing having a top surface, a bottom surface, a first side and a second side and defining a chamber therein, wherein the rotatable wheel is carried within the chamber of the housing;
a first and second adjustable vent assembly including a frame having defined grooves therein, a valve motor, a screw horizontally connected and extending from the valve motor and threadably attached to a vent support, said vent supports having a pair of vents and is slidably adjusted by the valve motor so that one of the pair of vents is open to receive or expel air or steam and one of the vents is blocked;
a means for supplying air or steam pressure to the apparatus; and
a motor means to effect rotation of the rotatable wheel.

2. The wheel thruster as recited in claim 1, wherein the means for driving said rotatable wheel comprises a shaft passing rotatably through the wheel.

3. The wheel thruster apparatus as recited in claim 1, further comprising a flow divider carried within the housing, wherein the air or steam passes through the flow divider and into the chamber such that the air or steam is distributed around the circumference of the rotatable wheel.

4. The wheel thruster apparatus of claim 1, wherein the rotation of the rotatable wheel and the inclusion of incoming air or steam pressure moves the mass blocks inward and outwardly into a weightless state to create a substantially constant unidirectional thrust.

5. The wheel apparatus as recited in claim 1, wherein one of the pair of vents of the first adjustable vent assembly selectively receives incoming air or steam pressure and the other vent is blocked, and one of the pair of vents of the second adjustable vent assembly selectively expels air or steam pressure and the other vent is blocked.

6. The wheel thruster as recited in of claim 1, wherein the direction of the unidirectional thrust is changed by reversing the direction of the incoming air or steam into the housing and slidably adjusting the pair of vents within the first and second adjustable vent assembly.
